(19) United States
(12) Patent Application Publication
(10) Pub. No.: US 2005/0275850 A1
(43) Pub. Date: Dec. 15, 2005

(54) Shape roughness measurement in optical metrology

(75) Inventors: Joerg Bischoff, Ilmenau (DE); Xinhui Niu, Los Altos, CA (US)

Correspondence Address: MORRISON & FOERSTER LLP, 425 MARKET STREET, SAN FRANCISCO, CA, 94105-2482, US

(73) Assignee: Timbre Technologies, Inc., Santa Clara, CA (US)

(21) Appl. No.: 10/856,002

(22) Filed: May 28, 2004

(51) Int. Cl. G01B 11/14

(52) U.S. Cl. 356/600; 356/625

(57) ABSTRACT

A simulated diffraction signal to be used in measuring shape roughness of a structure formed on a wafer using optical metrology is generated by defining an initial model of the structure. A statistical function of shape roughness is defined. A statistical perturbation is derived based on the statistical function and superimposed on the initial model of the structure to define a modified model of the structure. A simulated diffraction signal is generated based on the modified model of the structure.

### BACKGROUND

1. Field of the Invention

The present application relates to optical metrology, and more particularly to shape roughness measurement in optical metrology.

2. Related Art

Optical metrology involves directing an incident beam at a structure, measuring the resulting diffracted beam, and analyzing the diffracted beam to determine various characteristics, such as the profile of the structure. In semiconductor manufacturing, optical metrology is typically used for quality assurance. For example, after fabricating a periodic grating in proximity to a semiconductor chip on a semiconductor wafer, an optical metrology system is used to determine the profile of the periodic grating. By determining the profile of the periodic grating, the quality of the fabrication process utilized to form the periodic grating, and by extension the semiconductor chip proximate the periodic grating, can be evaluated.

Conventional optical metrology is used to determine the deterministic profile of a structure formed on a semiconductor wafer. For example, conventional optical metrology is used to determine the critical dimension of a structure. However, the structure may be formed with various stochastic effects, such as edge roughness, which are not measured using conventional optical metrology.

### SUMMARY

In one exemplary embodiment, a simulated diffraction signal to be used in measuring shape roughness of a structure formed on a wafer using optical metrology is generated by defining an initial model of the structure. A statistical function of shape roughness is defined. A statistical perturbation is derived from the statistical function and superimposed on the initial model of the structure to define a modified model of the structure. The simulated diffraction signal is generated based on the modified model of the structure.

### DESCRIPTION OF DRAWING FIGURES

The present application can be best understood by reference to the following description taken in conjunction with the accompanying drawing figures, in which like parts may be referred to by like numerals:

FIG. 1 depicts an exemplary optical metrology system;

FIGS. 2A-2E depict various hypothetical profiles of a structure;

FIG. 3 depicts an exemplary one-dimension structure;

FIG. 4 depicts an exemplary two-dimension structure;

FIG. 5 is a top view of an exemplary structure;

FIG. 6 is a top view of another exemplary structure;

FIG. 7 is an exemplary process for generating a simulated diffraction signal;

FIG. 8A is an initial model of an exemplary structure;

FIG. 8B is a modified model of the exemplary structure depicted in FIG. 8A;

FIG. 9A is an initial model of another exemplary structure;

FIG. 9B is a modified model of the exemplary structure depicted in FIG. 9A;

FIG. 10 depicts elementary cells defined for a set of exemplary structures;

FIG. 11A depicts one of the elementary cells depicted in FIG. 10 with an initial model;

FIG. 11B depicts the elementary cell depicted in FIG. 11A with a modified model;

FIG. 12A depicts the elementary cell depicted in FIG. 11B discretized;

FIG. 12B depicts a portion of the discretized elementary cell depicted in FIG. 12A;

FIG. 13 depicts elementary cells defied for another set of exemplary structures;

FIG. 14A depicts one of the elementary cells depicted in FIG. 14A with an initial model;

FIG. 14B depicts the elementary cell depicted in FIG. 14A with a modified model;

FIG. 15A depicts the elementary cell depicted in FIG. 14B discretized;

FIG. 15B depicts a portion of the discretized element cell depicted in FIG. 15A

FIG. 16A depicts an exemplary initial model defined in a vertical dimension;

FIG. 16B depicts an exemplary modified model after the exemplary initial model depicted in FIG. 16A is superimposed by a statistical function of shape roughness defined in a vertical dimension; and

FIG. 16C depicts the modified model depicted in FIG. 16B discretized.

### DETAILED DESCRIPTION

The following description sets forth numerous specific configurations, parameters, and the like. It should be recognized, however, that such description is not intended as a limitation on the scope of the present invention, but is instead provided as a description of exemplary embodiments.

1. Optical Metrology

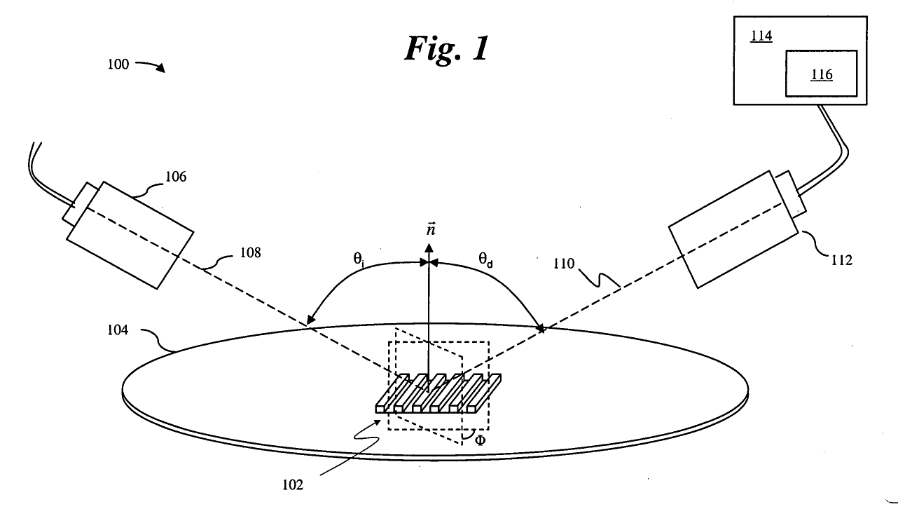

With reference to FIG. 1, an optical metrology system 100 can be used to examine and analyze a structure. For example, optical metrology system 100 can be used to determine the profile of a periodic grating 102 formed on wafer 104. As described earlier, periodic grating 102 can be formed in test areas on wafer 104, such as adjacent to a device formed on wafer 104. Alternatively, periodic grating 102 can be formed in an area of the device that does not interfere with the operation of the device or along scribe lines on wafer 104.

As depicted in FIG. 1, optical metrology system 100 can include a photometric device with a source 106 and a detector 112. Periodic grating 102 is illuminated by an incident beam 108 from source 106. In the present exemplary embodiment, incident beam 108 is directed onto periodic grating 102 at an angle of incidence θᵢ with respect to normal n of periodic grating 102 and an azimuth angle Φ (i.e., the angle between the plane of incidence beam 108 and the direction of the periodicity of periodic grating 102). Diffracted beam 110 leaves at an angle of θ_{d} with respect to normal n and is received by detector 112. Detector 112 converts the diffracted beam 110 into a measured diffraction signal.

To determine the profile of periodic grating 102, optical metrology system 100 includes a processing module 114 configured to receive the measured diffraction signal and analyze the measured diffraction signal. As described below, the profile of periodic grating 102 can then be determined using a library-based process or a regression-based process. Additionally, other linear or non-linear profile extraction techniques are contemplated.

2. Library-Based Process of Determining Profile of Structure

In a library-based process of determining the profile of a structure, the measured diffraction signal is compared to a library of simulated diffraction signals. More specifically, each simulated diffraction signal in the library is associated with a hypothetical profile of the structure. When a match is made between the measured diffraction signal and one of the simulated diffraction signals in the library or when the difference of the measured diffraction signal and one of the simulated diffraction signals is within a preset or matching criterion, the hypothetical profile associated with the matching simulated diffraction signal is presumed to represent the actual profile of the structure. The matching simulated diffraction signal and/or hypothetical profile can then be utilized to determine whether the structure has been fabricated according to specifications.

Thus, with reference again to FIG. 1, in one exemplary embodiment, after obtaining a measured diffraction signal, processing module 114 then compares the measured diffraction signal to simulated diffraction signals stored in a library 116. Each simulated diffraction signal in library 116 can be associated with a hypothetical profile. Thus, when a match is made between the measured diffraction signal and one of the simulated diffraction signals in library 116, the hypothetical profile associated with the matching simulated diffraction signal can be presumed to represent the actual profile of periodic grating 102.

The set of hypothetical profiles stored in library 116 can be generated by characterizing a hypothetical profile using a set of parameters, then varying the set of parameters to generate hypothetical profiles of varying shapes and dimensions. The process of characterizing a profile using a set of parameters can be referred to as parameterizing.

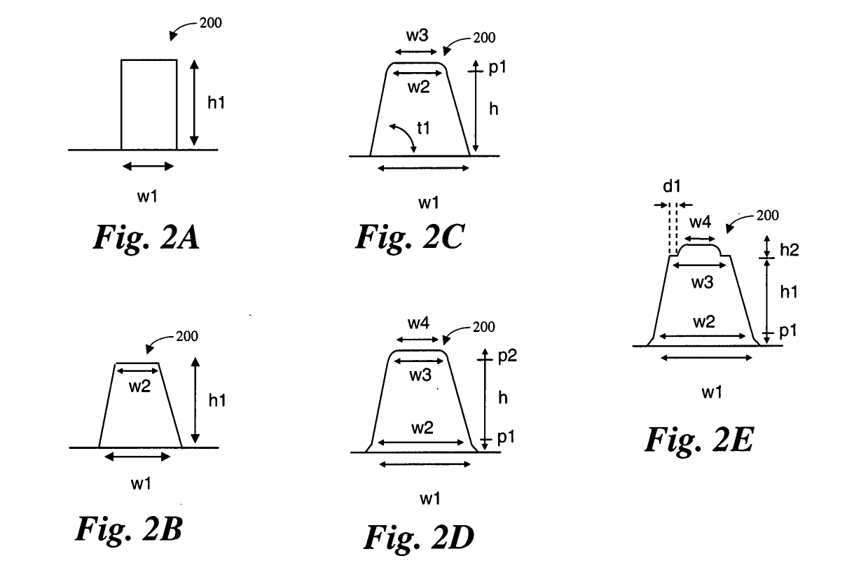

For example, as depicted in FIG. 2A, assume that hypothetical profile 200 can be characterized by parameters h1 and w1 that define its height and width, respectively. As depicted in FIGS. 2B to 2E, additional shapes and features of hypothetical profile 200 can be characterized by increasing the number of parameters. For example, as depicted in FIG. 2B, hypothetical profile 200 can be characterized by parameters h1, w1, and w2 that define its height, bottom width, and top width, respectively. Note that the width of hypothetical profile 200 can be referred to as the critical dimension (CD). For example, in FIG. 2B, parameter w1 and w2 can be described as defining the bottom CD and top CD, respectively, of hypothetical profile 200.

As described above, the set of hypothetical profiles stored in library 116 (FIG. 1) can be generated by varying the parameters that characterize the hypothetical profile. For example, with reference to FIG. 2B, by varying parameters h1, w1, and w2, hypothetical profiles of varying shapes and dimensions can be generated. Note that one, two, or all three parameters can be varied relative to one another.

With reference again to FIG. 1, the number of hypothetical profiles and corresponding simulated diffraction signals in the set of hypothetical profiles and simulated diffraction signals stored in library 116 (i.e., the resolution and/or range of library 116) depends, in part, on the range over which the set of parameters and the increment at which the set of parameters are varied. In one exemplary embodiment, the hypothetical profiles and the simulated diffraction signals stored in library 116 are generated prior to obtaining a measured diffraction signal from an actual structure. Thus, the range and increment (i.e., the range and resolution) used in generating library 116 can be selected based on familiarity with the fabrication process for a structure and what the range of variance is likely to be. The range and/or resolution of library 116 can also be selected based on empirical measures, such as measurements using AFM, X-SEM, and the like.

For a more detailed description of a library-based process, see U.S. patent application Ser. No. 09/907,488, titled GENERATION OF A LIBRARY OF PERIODIC GRATING DIFFRACTION SIGNALS, filed on Jul. 16, 2001, which is incorporated herein by reference in its entirety.

3. Regression-Based Process of Determining Profile of Structure

In a regression-based process of determining the profile of a structure, the measured diffraction signal is compared to a simulated diffraction signal (i.e., a trial diffraction signal). The simulated diffraction signal is generated prior to the comparison using a set of parameters (i.e., trial parameters) for a hypothetical profile (i.e., a hypothetical profile). If the measured diffraction signal and the simulated diffraction signal do not match or when the difference of the measured diffraction signal and one of the simulated diffraction signals is not within a preset or matching criterion, another simulated diffraction signal is generated using another set of parameters for another hypothetical profile, then the measured diffraction signal and the newly generated simulated diffraction signal are compared. When the measured diffraction signal and the simulated diffraction signal match or when the difference of the measured diffraction signal and one of the simulated diffraction signals is within a preset or matching criterion, the hypothetical profile associated with the matching simulated diffraction signal is presumed to represent the actual profile of the structure. The matching simulated diffraction signal and/or hypothetical profile can then be utilized to determine whether the structure has been fabricated according to specifications.

Thus, with reference again to FIG. 1, in one exemplary embodiment, processing module 114 can generate a simulated diffraction signal for a hypothetical profile, and then compare the measured diffraction signal to the simulated diffraction signal. As described above, if the measured diffraction signal and the simulated diffraction signal do not match or when the difference of the measured diffraction signal and one of the simulated diffraction signals is not within a preset or matching criterion, then processing module 114 can iteratively generate another simulated diffraction signal for another hypothetical profile. In one exemplary embodiment, the subsequently generated simulated diffraction signal can be generated using an optimization algorithm, such as global optimization techniques, which includes simulated annealing, and local optimization techniques, which includes steepest descent algorithm.

In one exemplary embodiment, the simulated diffraction signals and hypothetical profiles can be stored in a library 116 (i.e., a dynamic library). The simulated diffraction signals and hypothetical profiles stored in library 116 can then be subsequently used in matching the measured diffraction signal.

For a more detailed description of a regression-based process, see U.S. patent application Ser. No. 09/923,578, titled METHOD AND SYSTEM OF DYNAMIC LEARNING THROUGH A REGRESSION-BASED LIBRARY GENERATION PROCESS, filed on Aug. 6, 2001, which is incorporated herein by reference in its entirety.

4. Rigorous Coupled Wave Analysis

As described above, simulated diffraction signals are generated to be compared to measured diffraction signals. As will be described below, in one exemplary embodiment, simulated diffraction signals can be generated by applying Maxwell's equations and using a numerical analysis technique to solve Maxwell's equations. More particularly, in the exemplary embodiment described below, rigorous coupled-wave analysis (RCWA) is used. It should be noted, however, that various numerical analysis techniques, including variations of RCWA, can be used.

In general, RCWA involves dividing a profile into a number of sections, slices, or slabs (hereafter simply referred to as sections). For each section of the profile, a system of coupled differential equations generated using a Fourier expansion of Maxwell's equations (i.e., the components of the electromagnetic field and permittivity (E)). The system of differential equations is then solved using a diagonalization procedure that involves eigenvalue and eigenvector decomposition (i.e., Eigen-decomposition) of the characteristic matrix of the related differential equation system. Finally, the solutions for each section of the profile are coupled using a recurrent-coupling schema, such as a scattering matrix approach. For a description of a scattering matrix approach, see Lifeng Li, “Formulation and comparison of two recursive matrix algorithms for modeling layered diffraction gratings,” J. Opt. Soc. Am. A13, pp 1024-1035 (1996), which is incorporated herein by reference in its entirety. For a more detailed description of RCWA, see U.S. patent application Ser. No. 09/770,997, titled CACHING OF INTRA-LAYER CALCULATIONS FOR RAPID RIGOROUS COUPLED-WAVE ANALYSES, filed on Jan. 25, 2001, which is incorporated herein by reference in its entirety.

In RCWA, the Fourier expansion of Maxwell's equations is obtained by applying the Laurent's rule or the inverse rule. When RCWA is performed on a structure having a profile that varies in at least one dimension/direction, the rate of convergence can be increased by appropriately selecting between the Laurent's rule and the inverse rule. More specifically, when the two factors of a product between permittivity (ε) and an electromagnetic field (E) have no concurrent jump discontinuities, then the Laurent's rule is applied. When the factors (i.e., the product between the permittivity (ε) and the electromagnetic filed (E)) have only pairwise complimentary jump discontinuities, the inverse rule is applied. For a more detailed description, see Lifeng Li, “Use of Fourier series in the analysis of discontinuous periodic structures,” J. Opt. Soc. Am. A13, pp 1870-1876 (September, 1996), which is incorporated herein by reference in its entirety.

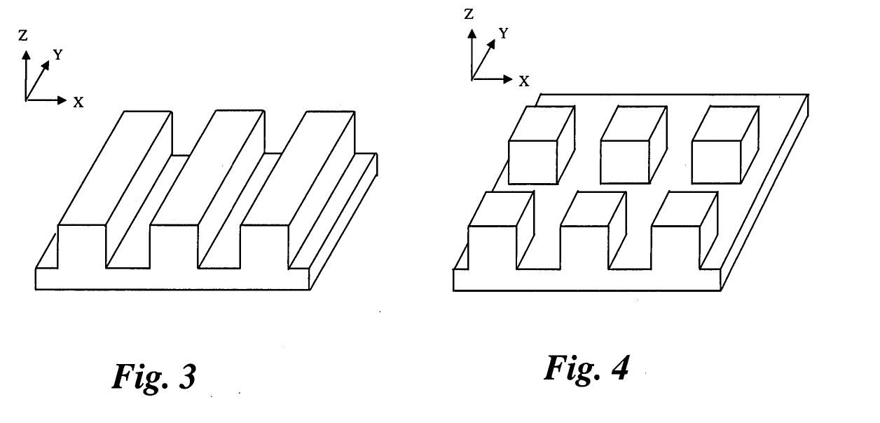

For a structure having a profile that varies in one dimension (referred to herein as a one-dimension structure), the Fourier expansion is performed only in one direction, and the selection between applying the Laurent's rule and the inverse rule is also made only in one direction. For example, a periodic grating depicted in FIG. 3 has a profile that varies in one dimension (i.e., the x-direction), and is assumed to be substantially uniform or continuous in the y-direction. Thus, the Fourier expansion for the periodic grating depicted in FIG. 3 is performed only in the x direction, and the selection between applying the Laurent's rule and the inverse rule is also made only in the x direction.

However, for a structure having a profile that varies in two or more dimensions (referred to herein as a two-dimension structure), the Fourier expansion is performed in two directions, and the selection between applying the Laurent's rule and the inverse rule is also made in two directions. For example, a periodic grating depicted in FIG. 4 has a profile that varies in two dimensions (i.e., the x-direction and the y-direction). Thus, the Fourier expansion for the periodic grating depicted in FIG. 4 is performed in the x direction and the y-direction, and the selection between applying the Laurent's rule and the inverse rule is also made in the x direction and the y direction.

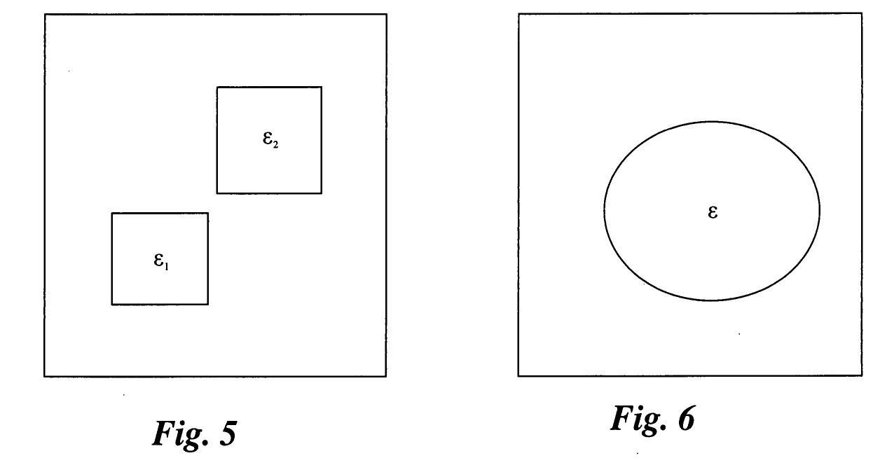

Additionally, for a one-dimension structure, Fourier expansion can be performed using an analytic Fourier transformation (e.g., a sin(v)/v function). However, for a two-dimension structure, Fourier expansion can be performed using an analytic Fourier transformation only when the structure has a rectangular patched pattern, such as that depicted in FIG. 5. Thus, for all other cases, such as when the structure has a non-rectangular pattern (an example of which is depicted in FIG. 6), either a numerical Fourier transformation (e.g., by means of a Fast Fourier Transformation) is performed or the shape is decomposed into rectangular patches to obtain the analytic solution patch by patch. See Lifeng Li, “New formulation of the Fourier modal method for crossed surface-relief gratings,” J. Opt. Soc. Am. A14, pp 2758-2767 (1997), which is incorporated herein by reference in its entirety

5. Machine Learning Systems

In one exemplary embodiment; simulated diffraction signals can be generated using a machine learning system employing a machine learning algorithm, such as back-propagation, radial basis function, support vector, kernel regression, and the like. For a more detailed description of machine learning systems and algorithms, see “Neural Networks” by Simon Haykin, Prentice Hall, 1999, which is incorporated herein by reference in its entirety. See also U.S. patent application Ser. No. 10/608,300, titled OPTICAL METROLOGY OF STRUCTURES FORMED ON SEMICONDUCTOR WAFERS USING MACHINE LEARNING SYSTEMS, filed on Jun. 27, 2003, which is incorporated herein by reference in its entirety.

6. Roughness Measurement

As described above, optical metrology can be used to determine the profile of a structure formed on a semiconductor wafer. More particularly, various deterministic characteristics of the structure (e.g., height, width, critical dimension, line width, and the like) can be determined using optical metrology. Thus the profile of the structure obtained using optical metrology is the deterministic profile of the structure. However, the structure may be formed with various stochastic effects, such as line edge roughness, slope roughness, side wall roughness, and the like. Thus, to more accurately determine the overall profile of the structure, in one exemplary embodiment, these stochastic effects are also measured using optical metrology. It should be recognized that the term line edge roughness or edge roughness is typically used to refer to roughness characteristics of structures other than just lines. For example, the roughness characteristic of a 2-dimensional structure, such as a via or hole, is also often referred to as a line edge roughness or edge roughness. Thus, in the following description, the term line edge roughness or edge roughness is also used in this broad sense.

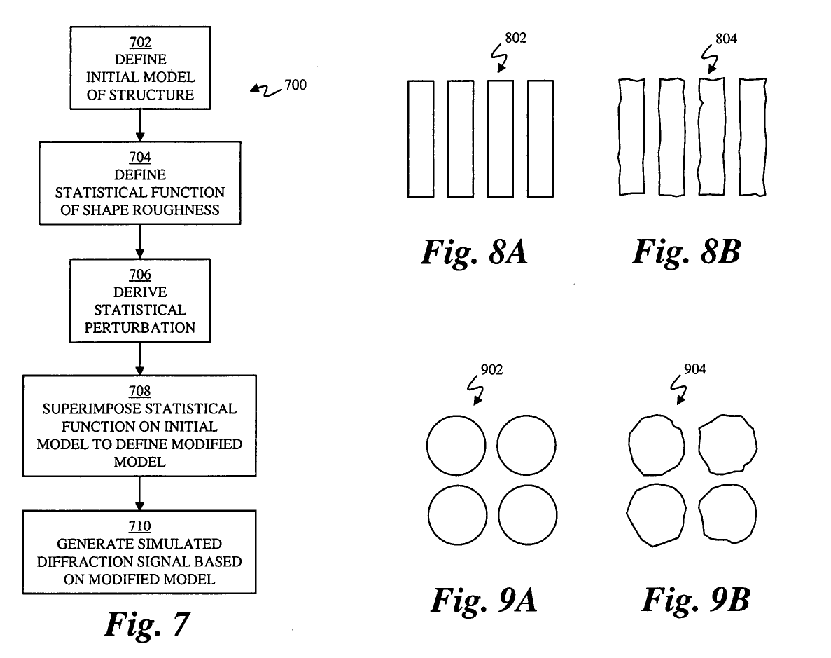

With reference to FIG. 7, an exemplary process 700 is depicted of generating a simulated diffraction signal to be used in measuring shape roughness of a structure using optical metrology. As will be described below, the structure can include line/space patterns, contact holes, T-shape islands, L-shape islands, corners, and the like.

In step 702, an initial model of the structure is defined. The initial model can be defined by smooth lines. For example, with reference to FIG. 8A, when the structure is a line/space pattern, initial model 802 can be defined by a rectangular shape. With reference to FIG. 9A, when the structure is a contact hole, initial model 902 can be defined by an elliptical shape. It should be recognized that various types of structures can be defined using various geometric shapes.

With reference again to FIG. 7, in step 704, a statistical function of shape roughness is defined. For example, one statistical function that can be used to characterize roughness is a root-means-square (rms) roughness, which describes the fluctuations of surface heights around an average surface height. More particularly, the Rayleigh criterion or Rayleigh smooth surface limit is:

$${( \frac{4 π σ \cdot cos {θ}_{i}}{λ} )}^{2} ⪡ 1$$

with σ being the rms of the stochastic surface, λ the probing wavelength and θᵢ the (polar) angle of incidence. The root mean square σ is defined in terms of surface height deviations from the mean surface as:

$$σ = {( {lim}_{L \to ∞} \frac{1}{L} {\int }_{- L / 2}^{L / 2} {[ z ( x ) - \overline{z} ]}^{2} ⅆ x )}^{1 / 2}$$

L is a finite distance in the lateral direction over which the integration is performed.

Another statistical function that can be used to characterize roughness is Power Spectrum Density (PSD). More particularly, the (one-dimensional) PSD of a surface is the squared Fourier integral of z(x):

$$PSD ( {f}_{x} ) = {lim}_{L \to ∞} \frac{1}{L} {\vert {\int }_{- L / 2}^{L / 2} z ( x ) \cdot {ⅇ}^{- j 2 π {f}_{x} x} ⅆ x \vert}^{2}$$

Here, fₓ is the spatial frequency in x-direction. Because the PSD is symmetric, it is fairly common to plot only the positive frequency side. Some characteristic PSD-functions are Gaussian, exponential and fractal.

The rms can be derived directly from the zeroth moment of the PSD as follows:

$$σ = 2 {\int }_{{f}_{min}}^{{f}_{max}} {( 2 π {f}_{x} )}^{0} \cdot PSD ( {f}_{x} ) ⅆ {f}_{x}$$

Note that the measured rms is bandwidth limited due to measurement limitations. More particularly, the least spatial frequency fₘᵢₙ is determined by the closest-to-specular resolved scatter angle and fₘₐₓ is determined by the evanescent cutoff. Both scale with the probing wavelength via the grating equation, i.e., lower wavelengths enable access to higher spatial frequencies and higher wavelength enable lower spatial frequencies to detect.

Still another statistical function that can be used to characterize roughness is an auto-correlation function (ACF), meaning a self-convolution of the surface expressed by:

$$ACF ( τ ) = {lim}_{L \to ∞} \frac{1}{L} {\int }_{- L / 2}^{L / 2} z ( x ) \cdot z ( x + τ ) ⅆ x$$

According to the Wiener-Khinchin theorem, the PSD and the ACF are a Fourier transform pair. Thus they expressing the same information differently.

When the Ralyleigh criterion is met, the PSD is also directly proportional to a Bi-directional Scatter Distribution Function (BSDF). For smooth-surface statistics (i.e., when the Rayleigh criterion is met), the BSDF is equal to the ratio of differential radiance to differential irradiance, which is measured using angle-resolved scattering (ARS) techniques.

It should be recognized that the roughness of a surface can be defined using various statistical functions. See, John C. Stover, “Optical Scattering,” SPIE Optical Engineering Press, Second Edition, Bellingham Wash. 1995, which is incorporated herein by reference in its entirety.

In step 706, a statistical perturbation is derived from the statistical function defined in step 704. In step 708, the statistical function perturbation derived in step 704 is superimposed on the initial model of the structure defined in step 702 to define a modified model of the structure. For example, with reference to FIGS. 8A and 8B, modified model 804 is depicted of initial model 802 of a line/space structure. With reference to FIGS. 9A and 9B, modified model 904 is depicted of initial model 902 of a contact hole structure.

With reference again to FIG. 7, in step 710, a simulated diffraction signal is generated based on the modified model defined in step 708. As described above, the simulated diffraction signal can be generated based on the modified model utilizing a numerical analysis technique, such as RCWA, or a machine learning system.

In one exemplary embodiment, to generate the simulated diffraction signal, an elementary cell is defined. The modified model in the elementary cell is discretized. For example, the modified model in the elementary cell is divided into a plurality of pixel elements, and an index of refraction and a coefficient of extinction (n & k) values are assigned to each pixel. Maxwell's equations are applied to the discretized model (including the Fourier transform of the n & k distribution), then solved using a numerical analysis technique, such as RCWA, to generate the simulated diffraction signal.

For example, with reference to FIG. 10, when the structure is a line/space pattern, various elementary cells 1002a, 1002b and 1002c can be defined with various pitches defined across the lines. As depicted in FIG. 10, the pitch in the x-direction is an integer multiple of the line/space period, but the pitch in the y-direction can be chosen arbitrarily. One condition for an elementary cell is that it replicate exactly in the pattern. The line/space pattern can be reconstructed by butting elementary cells together.

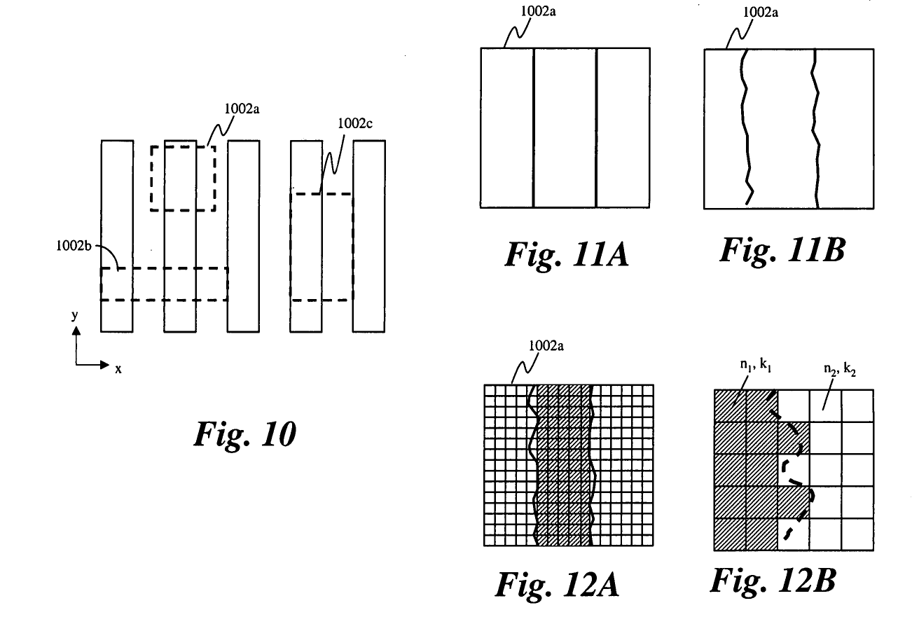

With reference to FIG. 11A, cell 1002a is depicted with an initial model of a deterministic basic feature of the structure. With reference to FIG. 11B, cell 1002a is depicted with the modified model of the structure after the initial model is superimposed with a statistical function, such as rms roughness, PSD, ACF, and the like. With reference to FIG. 12A, the modified model is discretized by dividing the elementary cell into a plurality of pixel elements. With reference to FIG. 12B, each pixel is assigned n & k values. In the example depicted in FIG. 12B, the pixels within a line is assigned one n & k value (n₁ & k₁), and the pixels within a space is assigned another n & k value (n₂ & k₂).

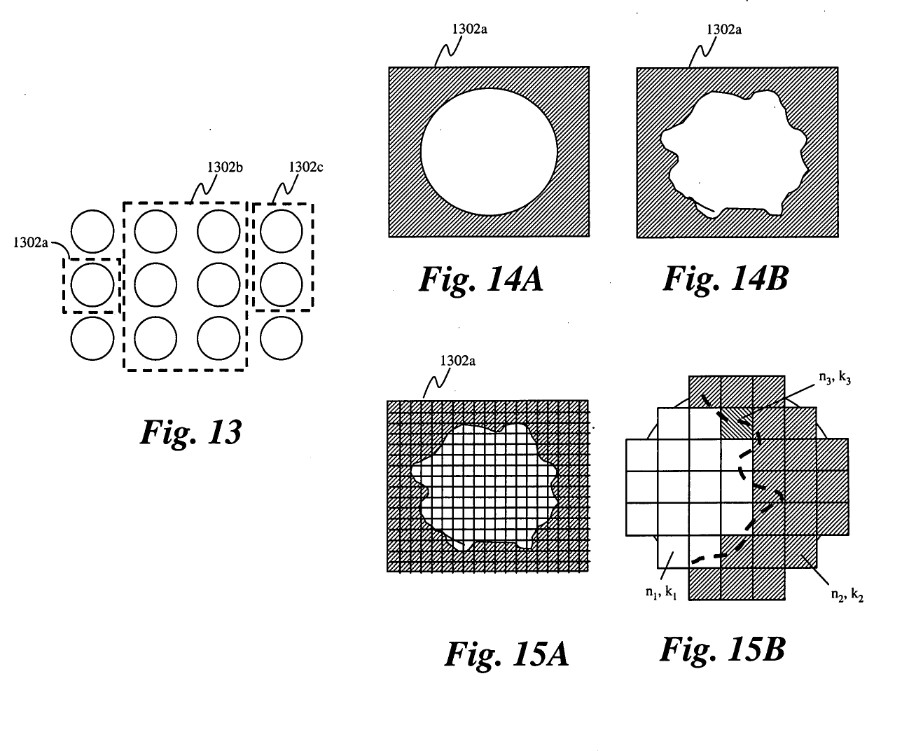

With reference to FIG. 13, when the structure is a contact hole, various elementary cells 1302a, 1302b and 1302c can be defined with the pitch in the x direction and the y-direction being multiples of the contact hole pitch. As depicted in FIG. 13, an elementary cell includes at least one whole contact hole.

With reference to FIG. 14A, cell 1302a is depicted with an initial model of the structure defined by smooth lines. With reference to FIG. 14B, cell 1302a is depicted with the modified model of the structure after the initial model is superimposed with a statistical function, such as rms roughness, PSD, ACF, and the like. With reference to FIG. 15A, the modified model is discretized by dividing the elementary cell into a plurality of pixel elements. With reference to FIG. 15B, each pixel is assigned n & k values. In the example depicted in FIG. 15B, the pixels within a contact hole are assigned one n & k value (n₁, k₁), the pixels outside the contact hole are assigned another n & k value (n₂, k₂). As also depicted in FIG. 15B, any number of n & k values can be assigned. For example, a pixel with a portion within a contact hole and a portion outside the contact hole can be assigned a third n & k value (n₃, k₃), which can be a weighted average of the adjacent n & k values.

Thus far the initial model of the structure and the statistical function of shape roughness have been depicted and described in a lateral dimension. It should be recognized, however, that the initial model and the statistical function of shape roughness can be defined in a vertical dimension and a combination of lateral and vertical dimensions.

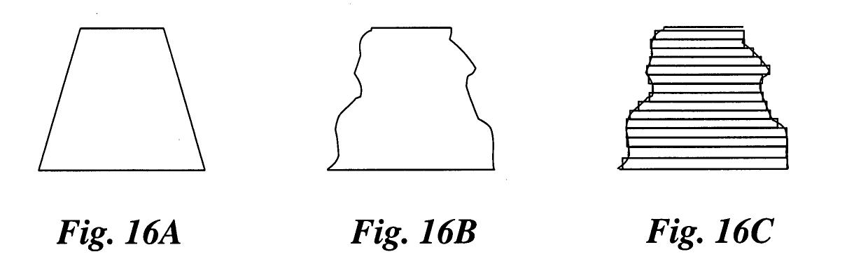

For example, with reference to FIG. 16A, an initial model of a structure defined by smooth lines in a vertical dimension is depicted. With reference to FIG. 16B, a modified model of the structure is depicted after the initial model is superimposed with a statistical function defined in a vertical dimension. With reference to FIG. 16C, the modified model is discretized by dividing the modified model into a plurality of slices. A simulated diffraction signal can be generated for the modified model using RCWA.

With reference again to FIG. 7, to create a more sophisticated model, in one exemplary embodiment, after steps 702 to 710 are performed to generate a first simulated diffraction signal based on a first modified model, step 706 is repeated to derive at least another statistical perturbation from the same statistical function of shape roughness for the initial model defined in step 704. Step 708 is also repeated to superimpose the at least another statistical perturbation on the initial model defined in step 702 to define at least another modified model. Step 710 is then repeated to generate at least another simulated diffraction signal based on the at least another modified model. The first simulated diffraction signal and the at least another simulated diffraction signal are then averaged.

As described above, the generated diffraction signal can be used to determine the shape of a structure to be examined. For example, in a library based system, steps 702 to 710 are repeated to generate a plurality of modified model and corresponding simulated diffraction signal pairs. In particular, the statistical function in step 704 is varied, which in turn varies the statistical perturbation derived in step 706 to define varying modified models in step 708. Varying simulated diffraction signals are then generated in step 710 using the various modified models defined in step 708. The plurality of modified model and corresponding simulated diffraction signal pairs are stored in a library. A diffraction signal is measured from directing an incident beam at a structure to be examined (a measured diffraction signal). The measured diffraction signal is compared to one or more simulated diffraction signals stored in the library to determine the shape of the structure being examined.

Alternatively, in a regression based system, a diffraction signal is measured (a measured diffraction signal). The measured diffraction signal is compared to the simulated diffraction signal generated in step 710. When the measured diffraction signal and the simulated diffraction signal generated in step 710 do not match within a preset criteria, steps 702 to 710 of process 700 are repeated to generate a different simulated diffraction signal. In generating the different simulated diffraction signal, the statistical function in step 704 is varied, which in turn varies the statistical perturbation derived in step 706 to define a different modified model of the structure in step 708, which is used to generate the different simulated diffraction signal in step 710.

Although exemplary embodiments have been described, various modifications can be made without departing from the spirit and/or scope of the present invention. Therefore, the present invention should not be construed as being limited to the specific forms shown in the drawings and described above.

1. A method of generating a simulated diffraction signal to be used in measuring shape roughness of a structure formed on a wafer using optical metrology, the method comprising:
(a) defining an initial model of the structure;
(b) defining a statistical function of shape roughness;
(c) deriving a statistical perturbation based on the statistical function;
(d) superimposing the statistical perturbation on the initial model of the structure to define a modified model of the structure; and
(e) generating a simulated diffraction signal based on the modified model of the structure.

2. The method of claim 1, wherein the initial model of the structure is defined by smooth lines, and has a rectangular shape when the structure is a line/space pattern or an elliptical shape when the structure is a contact hole.

3. The method of claim 1, wherein the initial model of the structure is defined by smooth lines and has a T-shaped island or an L-shaped island when the structure is a via.

4. The method of claim 1, wherein the initial model of the structure is defined by smooth lines and has a trapezoidal shape when the structure is a line/space pattern.

5. The method of claim 1, wherein the initial model of the structure is defined by smooth lines, and wherein the statistical function of shape roughness is defined in a lateral dimension, a vertical dimension, or lateral and vertical dimensions.

6. The method of claim 1, wherein the statistical function comprises root-mean-square roughness, autocorrelation function, or power spectrum density.

7. The method of claim 1, wherein generating a simulated diffraction signal comprises:
discretizing the modified model;
applying Maxwell's equations to the discretized model; and
solving Maxwell's equations using a numerical analysis technique to generate the simulated diffraction signal.

8. The method of claim 7, further comprising:
defining an elementary cell containing the modified model, wherein the modified model in the elementary cell is discretized.

9. The method of claim 8, wherein discretizing the model comprises:
dividing the elementary cell into a plurality of pixel elements; and
assigning an index of refraction and a coefficient of extinction (n & k) values to each pixel element.

10. The method of claim 9, wherein the numerical analysis technique is rigorous coupled-wave analysis.

11. The method of claim 8, wherein the elementary cell includes multiple periods of the structure.

12. The method of claim 1, further comprising:
deriving at least another statistical perturbation based on the statistical function of shape roughness defined in step (b);
superimposing the at least another statistical perturbation on the initial model defined in step (a) to define at least another modified model of the structure;
generating at least another simulated diffraction signal based on the at least another modified model of the structure; and
averaging the simulated diffraction signal generated in step (e) and the at least another simulated diffraction signal.

13. The method of claim 1, further comprising:
repeating steps (a) to (e) to generate a plurality of modified model and corresponding simulated diffraction signal pairs, wherein the statistical function in step (b) is varied to define varying modified models of the structure in step (d) and to generate varying simulated diffraction signals in step (e);
storing the plurality modified model and corresponding simulated diffraction signal pairs in a library;
obtaining a diffraction signal measured from directing an incident beam at a structure being examined (a measured diffraction signal); and
comparing the measured diffraction signal to one or more of the simulated diffraction signals stored in the library to determine the shape of the structure being examined.

14. The method of claim 1, further comprising:
obtaining a diffraction signal measured from directing an incident beam at a structure being examined (a measured diffraction signal);
comparing the measured diffraction signal to the simulated diffraction signal generated in step (e); and
when the measured diffraction signal and the simulated diffraction signal generated in step (e) do not match within a preset criteria:
repeating steps (a) to (e) to generate a different simulated diffraction signal, wherein the statistical function in step (b) is varied to define a different modified model of the structure in step (d) and to generate the different simulated diffraction signal in step (e); and
repeating the comparing step using the different simulated diffraction signal.

15. The method of claim 1, wherein the simulated diffraction signal is generated using a machine learning system.

16. A method of generating a simulated diffraction signal to be used in measuring shape roughness of a structure formed on a wafer using optical metrology, the method comprising:
(a) defining an initial model of a deterministic basic feature of the structure;
(b) defining a statistical function of shape roughness;
(c) generating a statistical perturbation based on the statistical function;
(d) superimposing the statistical perturbation on the initial model to define a modified model of the structure; and
(e) generating a simulated diffraction signal based on the modified model of the structure.

17. The method of claim 16, wherein the initial model is defined by smooth lines, and has a rectangular shape when the structure is a line/space pattern or an elliptical shape when the structure is a contact hole.

18. The method of claim 16, wherein the initial model of the structure is defined by smooth lines and has a T-shaped island or an L-shaped island when the structure is a via.

19. The method of claim 16, wherein the initial model of the structure is defined by smooth lines and has a trapezoidal shape when the structure is a line/space pattern.

20. The method of claim 16, wherein the initial model of the structure is defined by smooth lines, and wherein the statistical function of shape roughness is defined in a lateral dimension, a vertical dimension, or lateral and vertical dimensions.

21. The method of claim 16, wherein the statistical function comprises root-mean-square roughness, autocorrelation function, or power spectrum density.

22. The method of claim 16, wherein generating a simulated diffraction signal comprises:
discretizing the modified model of the structure;
applying Maxwell's equations to the discretized model; and
solving Maxwell's equations using a numerical analysis technique to generate the simulated diffraction signal.

23. The method of claim 22, further comprising:
defining an elementary cell containing the modified model, wherein the modified model in the elementary cell is discretized.

24. The method of claim 23, wherein discretizing the model comprises:
dividing the elementary cell into a plurality of pixel elements; and
assigning an index of refraction and a coefficient of extinction (n & k) values to each pixel element.

25. The method of claim 24, wherein the numerical analysis technique is rigorous coupled-wave analysis.

26. The method of claim 16, wherein the simulated diffraction signal is generated using a machine learning system.

27. A computer-readable storage medium containing computer executable instructions for causing a computer to generate a simulated diffraction signal to be used in measuring shape roughness of a structure formed on a wafer using optical metrology, comprising instructions for:
(a) defining an initial model of the structure;
(b) defining a statistical function of shape roughness;
(c) deriving a statistical perturbation based on the statistical function;
(d) superimposing the statistical perturbation on the initial model of the structure to define a modified model of the structure; and
(e) generating a simulated diffraction signal based on the modified model of the structure.

28. A system to generate a simulated diffraction signal to be used in measuring shape roughness of a structure formed on a wafer using optical metrology, the system comprising:
an initial model of the structure;
a modified model of the structure defined by superimposing a statistical perturbation derived from a statistical function defined for the initial model of the structure; and
a simulated diffraction signal generated based on the modified model of the structure.
